(19) United States
(12) Patent Application Publication
(10) Pub. No.: US 2026/0208532 A1
(43) Pub. Date: Jul. 23, 2026

(54) RUBBER COMPOSITION FOR TIRE AND TIRE

(71) Applicant: Toyo Tire Corporation, Itami-shi (JP)

(72) Inventor: Shuhei Yamamoto, Itami-shi (JP)

(73) Assignee: Toyo Tire Corporation, Itami-shi (JP)

(21) Appl. No.: 19/449,822

(22) Filed: Jan. 15, 2026

(30) Foreign Application Priority Data
Jan. 20, 2025 (JP) 2025-007975
Jan. 20, 2025 (JP) 2025-007986

(51) Int. Cl. B60C 1/00; C08F 236/10; C08K 3/04; C08K 3/22; C08K 3/36; C08K 5/00; C08K 5/09; C08L 7/00

(52) U.S. Cl. CPC B60C 1/0016; C08F 236/10; C08K 3/04; C08K 3/22; C08K 3/36; C08K 5/0025; C08K 5/09; C08L 7/00; C08K 2003/2296

(57) ABSTRACT

The rubber composition for a tire according to an embodiment contains 100 parts by mass of a rubber component containing a diene rubber and 1 to 50 parts by mass of a mineral oil-derived reclaimed oil. (1) The rubber composition for a tire further contains 30 to 200 parts by mass of silica, and 100 parts by mass of the rubber component may contain 20 to 100 parts by mass of a styrene butadiene rubber. (2) Alternatively, the rubber composition for a tire further contains 15 to 200 parts by mass of carbon black, and 100 parts by mass of the rubber component may contain 20 to 100 parts by mass of a natural rubber.

### BACKGROUND OF THE INVENTION

### 1. Field of the Invention

The present invention relates to a rubber composition for a tire and a tire using the same.

### 2. Description of Related Art

In the production of a tire, a process oil is generally used to mix rubber which is difficult to knead during the productization step of the rubber. To substitute with a sustainable material, an attempt to substitute a process oil produced from petroleum with a vegetable oil has been made. For example, JP2008-274206A discloses that a vegetable oil such as soybean oil is blended in a rubber composition as a softener.

Here, as a reclaimed oil, an oil obtained by reclaiming a waste lubricating oil which is a mineral oil used as a lubricating oil in a factory, an automobile or the like is known (see Shunichiro TAKAOKA, “Study on Re-refining Methods for Waste Lubricating Oils”, Journal of the Japan Society of Waste Management Experts, Vol. 4, No. 4, pp. 152-158, 1993).

### SUMMARY OF THE INVENTION

As described above, it is known that a vegetable oil is used as a substitute for a process oil which is blended in a rubber composition for a tire, but the substitution is difficult because the vulcanization property decreases significantly when a vegetable oil is used, compared to that of a conventional petroleum process oil. A major cause thereof is believed to be a significant difference in the composition between a vegetable oil composed of triglycerides and a petroleum process oil composed of hydrocarbons such as paraffin.

In view of the above points, an object of an embodiment of the invention is to provide a rubber composition for a tire in which a reclaimed oil which substitutes for the conventional petroleum process oil is blended for sustainability.

The invention includes the embodiments shown below.
[1] A rubber composition for a tire containing 100 parts by mass of a rubber component containing a diene rubber and 1 to 50 parts by mass of a mineral oil-derived reclaimed oil.
[2] The rubber composition for a tire according to [1] which further contains 30 to 200 parts by mass of silica and in which 100 parts by mass of the rubber component contain 20 to 100 parts by mass of a styrene butadiene rubber.
[3] The rubber composition for a tire according to [2] in which 100 parts by mass of the rubber component contain 70 to 100 parts by mass of the styrene butadiene rubber.
[4] The rubber composition for a tire according to [2] in which 100 parts by mass of the rubber component contain 20 to 40 parts by mass of the styrene butadiene rubber, 30 to 50 parts by mass of a butadiene rubber, and 30 to 50 parts by mass of a natural rubber.
[5] The rubber composition for a tire according to [1] which further contains 15 to 200 parts by mass of carbon black and in which 100 parts by mass of the rubber component contain 20 to 100 parts by mass of a natural rubber.
[6] The rubber composition for a tire according to [5] in which 100 parts by mass of the rubber component contain 70 to 100 parts by mass of the natural rubber and 0 to 30 parts by mass of a butadiene rubber and/or a styrene butadiene rubber.
[7] The rubber composition for a tire according to [5] in which 100 parts by mass of the rubber component contain 30 to 70 parts by mass of the natural rubber, 10 to 50 parts by mass of a butadiene rubber, and 0 to 40 parts by mass of a styrene butadiene rubber.
[8] The rubber composition for a tire according to any one of [1] to [7] in which the mineral oil-derived reclaimed oil is a lubricating oil-derived reclaimed oil.
[9] The rubber composition for a tire according to any one of [1] to [8] in which the mineral oil-derived reclaimed oil has a glass transition point of −90° C. to −75° C., a number average molecular weight of 550 to 650, and a weight average molecular weight of 600 to 750.
[10] The rubber composition for a tire according to any one of [1] to [9] in which the kinetic viscosity of the mineral oil-derived reclaimed oil at 40° C. is 40 to 70 mm²/s.
[11] The rubber composition for a tire according to any one of [1] to [10] in which in the carbon-type composition of the mineral oil-derived reclaimed oil analyzed by ring analysis, the percentage of paraffinic carbon (C_{P}%) is 55 to 80%, the percentage of naphthenic carbon (C_{N}%) is 20 to 40%, and the percentage of aromatic carbon (C_{A}%) is 0 to 15%.
[12] A tire having a rubber member formed with the rubber composition for a tire according to any one of [1] to [11].
[13] The tire according to [12] in which the rubber member is a tread rubber or a base tread.

According to the embodiment of the invention, a rubber composition for a tire having excellent sustainability can be provided.

### DESCRIPTION OF EMBODIMENTS

The rubber composition for a tire according to the embodiment (also simply called “rubber composition” below) contains a rubber component, a filler, and a mineral oil-derived reclaimed oil. More specifically, the embodiment includes a first embodiment and a second embodiment below.

The rubber composition for a tire according to the first embodiment contains 100 parts by mass of a rubber component containing 20 to 100 parts by mass of a styrene butadiene rubber, 30 to 200 parts by mass of silica, and 1 to 50 parts by mass of a mineral oil-derived reclaimed oil. In the first embodiment, the abrasion resistance, and the fatigue resistance in addition to the sustainability are excellent.

The rubber composition for a tire according to the second embodiment contains 100 parts by mass of a rubber component containing 20 to 100 parts by mass of a natural rubber, 15 to 200 parts by mass of carbon black, and 1 to 50 parts by mass of a mineral oil-derived reclaimed oil. In the second embodiment, the breaking property and the low fuel consumption in addition to the sustainability are excellent.

### [Rubber Component]

The rubber component contains a diene rubber. Specifically, a styrene butadiene rubber (SBR) is contained as the diene rubber in the first embodiment. In the second embodiment, a natural rubber (NR) is contained as the diene rubber. Here, the diene rubber refers to a rubber having a repeating unit corresponding to a diene monomer having a conjugated double bond and contains a carbon-carbon double bond in the main chain of the polymer.

The SBR may be a solution-polymerized styrene butadiene rubber (SSBR) or an emulsion-polymerized styrene butadiene rubber (ESBR). The SBR may be a modified styrene butadiene rubber in which the terminal, the main chain, or the like has been modified (modified SBR) or an unmodified styrene butadiene rubber without modification (unmodified SBR), or modified SBR and unmodified SBR may be used in combination. As the modified SBR, SBR which has been modified with a functional group by introducing the functional group to the terminal and/or the main chain is used. The functional group preferably contains an oxygen atom and/or a nitrogen atom, and examples thereof include at least one selected from the group consisting of an amino group, a hydroxy group, an alkoxy group, an alkoxysilyl group, an epoxy group, and a carboxy group.

The natural rubber is a polymer of isoprene, and the most part thereof is composed of cis-1,4 bonds. As the natural rubber, various natural rubbers which are generally used for a rubber composition for a tire such as a ribbed smoked sheet (RSS) can be used.

In the first embodiment, 100 parts by mass of the rubber component contain 20 to 100 parts by mass of SBR. That is, the rubber component contains 20 mass % or more of SBR and may be SBR alone. For example, 100 parts by mass of the rubber component may contain 20 to 100 parts by mass of SBR and 0 to 80 parts by mass of another diene rubber, may contain 20 to 90 parts by mass of SBR and 10 to 80 parts by mass of another diene rubber or may contain 50 to 80 parts by mass of SBR and 20 to 50 parts by mass of another diene rubber. Alternatively, 100 parts by mass of the rubber component may contain 70 to 100 parts by mass of SBR and 0 to 30 parts by mass of another diene rubber or may contain 80 to 100 parts by mass of SBR and 0 to 20 parts by mass of another diene rubber. Here, examples of the other diene rubber include a natural rubber (NR), a synthetic isoprene rubber (IR), a butadiene rubber (BR), and the like. Any one kind thereof or a combination of two or more kinds thereof can be used. The diene rubber may be a modified diene rubber in which the terminal, the main chain, or the like has been modified.

In the first embodiment, 100 parts by mass of the rubber component may contain 20 to 40 parts by mass of SBR, 30 to 50 parts by mass of BR, and 30 to 50 parts by mass of NR. Alternatively, 100 parts by mass of the rubber component may contain 70 to 90 parts by mass of SBR and 10 to 30 parts by mass of NR.

In the second embodiment, 100 parts by mass of the rubber component contain 20 to 100 parts by mass of a natural rubber. That is, the rubber component contains 20 mass % or more of a natural rubber and may be a natural rubber alone. The rubber component preferably contains 30 mass % or more of a natural rubber and more preferably contains 40 mass % or more of a natural rubber. Alternatively, 100 parts by mass of the rubber component may contain 20 to 100 parts by mass of a natural rubber and 0 to 80 parts by mass of another diene rubber, may contain 30 to 90 parts by mass of a natural rubber and 10 to 70 parts by mass of another diene rubber or may contain 40 to 70 parts by mass of a natural rubber and 30 to 60 parts by mass of another diene rubber. Here, examples of the other diene rubber include a synthetic isoprene rubber (IR), a butadiene rubber (BR), a styrene butadiene rubber (SBR), and the like. Any one kind thereof or a combination of two or more kinds thereof can be used. The diene rubber may be a modified diene rubber in which the terminal, the main chain, or the like has been modified.

In the second embodiment, 100 parts by mass of the rubber component may contain 30 to 70 parts by mass of NR, 10 to 50 parts by mass of BR, and 0 to 40 parts by mass of SBR or may contain 40 to 60 parts by mass of NR, 20 to 40 parts by mass of BR, and 10 to 30 parts by mass of SBR. Alternatively, 100 parts by mass of the rubber component may contain 70 to 100 parts by mass of NR and 0 to 30 parts by mass of BR and/or SBR as an optional component or may contain 80 to 100 parts by mass of NR and 0 to 20 parts by mass of BR and/or SBR as an optional component.

### [Filler]

In the rubber composition, a reinforcing filler (an inorganic filler) such as silica and carbon black is blended. Silica is an essential component as the filler in the first embodiment, and carbon black is an essential component as the filler in the second embodiment.

Examples of the silica include wet silica, dry silica, and the like, and wet silica such as wet-precipitated silica and wet-gelled silica is preferably used.

The carbon black is not particularly limited, and various kinds of carbon black which are generally used for a rubber composition for a tire can be used. In an embodiment, as the carbon black, carbon black having a nitrogen adsorption specific surface area N₂SA of 30 to 110 m²/g may be used, carbon black having a nitrogen adsorption specific surface area N₂SA of 50 to 90 m²/g may be used, or carbon black having a nitrogen adsorption specific surface area N₂SA of 60 to 80 m²/g may be used. Here, the nitrogen adsorption specific surface area N₂SA of the carbon black is measured in accordance with JIS K6217-2 A method: 2017.

In the first embodiment, the silica content of the rubber composition is 30 to 200 parts by mass based on 100 parts by mass of the rubber component. The silica content, based on 100 parts by mass of the rubber component, is preferably 35 to 150 parts by mass, more preferably 40 to 120 parts by mass, further preferably 50 to 100 parts by mass.

In the first embodiment, the filler may be silica alone, but another filler may be blended with silica. As the other filler, carbon black is preferably used. The proportion of the silica in the filler is preferably 60 mass % or more, more preferably 70 mass % or more. When the rubber composition contains carbon black, the carbon black content is not particularly limited and may be, for example, 3 to 30 parts by mass or 5 to 20 parts by mass based on 100 parts by mass of the rubber component.

In the second embodiment, the carbon black content of the rubber composition is 15 to 200 parts by mass based on 100 parts by mass of the rubber component. The carbon black content, based on 100 parts by mass of the rubber component, is preferably 20 to 150 parts by mass, more preferably 30 to 100 parts by mass, more preferably 40 to 90 parts by mass, further preferably 50 to 80 parts by mass.

In the second embodiment, the filler may be carbon black alone, or another filler may be blended with carbon black. An example of the other filler is silica. The proportion of the carbon black in the filler is preferably 60 mass % or more, more preferably 80 mass % or more, further preferably 90 mass % or more.

### [Mineral Oil-Derived Reclaimed Oil]

A mineral oil-derived reclaimed oil (also simply called “reclaimed oil” below) is blended in the rubber composition according to the embodiment. The mineral oil-derived reclaimed oil is a reclaimed oil obtained by reclaiming a mineral oil after use. Because the mineral oil-derived reclaimed oil is originally produced from a petroleum raw material like an existing process oil, the composition is relatively similar to that of the existing process oil. Accordingly, the deterioration of the vulcanization property which is observed when a vegetable oil that is considered as a substitute as a sustainable oil is blended does not easily occur, and a rubber composition for a tire having excellent sustainability can be provided when a process oil is substituted with the mineral oil-derived reclaimed oil. One of the factors which make it difficult to substitute a process oil with a vegetable oil is believed to be the difference in the glass transition points. The mineral oil-derived reclaimed oil, however, has an approximately equivalent glass transition point to that of an existing process oil, and thus the influence on the viscoelasticity is expected to be small. Moreover, unlike a vegetable oil, the mineral oil-derived reclaimed oil is composed of paraffins, naphthenes, and aromatics as the composition like an existing process oil, and thus the influence on the unvulcanization property is believed to be small. Therefore, the mineral oil-derived reclaimed oil has comparable properties to those of the existing process oil, thus suppresses the deterioration of the vulcanization property, which occurs when the process oil is substituted with a vegetable oil, and can substitute for the process oil. Accordingly, for example, the rubber composition according to the first embodiment can improve the sustainability without deteriorating the vulcanization property such as the abrasion resistance and the fatigue resistance. Moreover, the rubber composition according to the second embodiment can improve the sustainability without deteriorating the vulcanization property such as the breaking property and the low heat generation property.

The reclaimed oil is preferably a lubricating oil-derived reclaimed oil. The lubricating oil-derived reclaimed oil is a reclaimed oil obtained by reclaiming a mineral oil-based lubricating oil after use (namely, a waste lubricating oil). Examples of the lubricating oil include an engine oil, a hydraulic device oil, a gear oil, and the like and preferably include an engine oil. Because a lubricating oil such as an engine oil generally contains an oxidation inhibitor, the lubricating oil-derived reclaimed oil may contain an oxidation inhibitor. It is believed that, when the lubricating oil-derived reclaimed oil contains an oxidation inhibitor, for example, the rubber composition according to the first embodiment can suppress the cleavage of the molecular chains of the rubber polymer due to radicals that generate in a fatigue test of a vulcanized rubber and can improve the fatigue resistance. Moreover, it is believed that the rubber composition according to the second embodiment can suppress the cleavage of the molecular chains of the rubber polymer due to radicals that generate when a vulcanized rubber deteriorates.

Examples of the oxidation inhibitor include at least one selected from the group consisting of a phenolic oxidation inhibitor, an amine-based oxidation inhibitor, and a thiol-based oxidation inhibitor. Examples of the phenolic oxidation inhibitor include butylated hydroxytoluene (BHT), tocopherol (vitamin E), propyl gallate, and the like. The phenolic oxidation inhibitors have an effect of suppressing oxidation reaction and preventing oxidation in the reclaimed oil. Examples of the amine-based oxidation inhibitor include phenyl α-naphthylamine (PANA), diphenylamine, and the like. The amine-based oxidation inhibitors play a role of suppressing oxidation reaction in the reclaimed oil and preventing deterioration of the reclaimed oil. Examples of the thiol-based oxidation inhibitor include dithiol, trithiol, and the like. The thiol-based oxidation inhibitors have a potent reducing effect on oxidation reaction and have an effect of preventing oxidation in the reclaimed oil. The amount of the oxidation inhibitor contained in the reclaimed oil is not particularly limited and may be, for example, 5 mass % or less or 0.01 to 2 mass %.

Because an anti-friction agent is sometimes blended in a lubricating oil such as an engine oil, the lubricating oil-derived reclaimed oil sometimes contains an anti-friction agent. Examples of the anti-friction agent include at least one selected from the group consisting of a dialkyl dithiophosphate, a dialkyl sulfide, and a dialkyl polyoxymethylene. The amount of the anti-friction agent contained in the reclaimed oil is not particularly limited and may be, for example, 5 mass % or less or 0.01 to 2 mass %.

The glass transition point (Tg) of the reclaimed oil is preferably −90° C. to −75° C., more preferably −85 to −80° C. The glass transition point is measured with a differential scanning calorimeter (DSC), and the specific measurement method is as described in the Examples. The glass transition point is the average value of Tg1 and Tg2 described below.

The number average molecular weight (Mn) of the reclaimed oil is 550 to 650, and the weight average molecular weight (Mw) is preferably 600 to 750. The values are larger than those of an existing process oil. Accordingly, the rubber composition according to the first embodiment is believed to contribute to improvement of the abrasion resistance and the fatigue resistance. Moreover, the rubber composition according to the second embodiment is believed to contribute to improvement of the breaking property and the low heat generation property. The Mn and the Mw are the molecular weights in terms of polystyrene measured by gel permeation chromatography (GPC), and the specific measurement method is as described in the Examples.

The kinetic viscosity of the reclaimed oil is not particularly limited, but the kinetic viscosity at 40° C. is preferably 40 to 70 mm²/s. Because of such a high kinetic viscosity, the rubber composition according to the first embodiment is believed to contribute to improvement of the abrasion resistance and the fatigue resistance. Moreover, the rubber composition according to the second embodiment is believed to contribute to improvement of the breaking property and the low heat generation property. The kinetic viscosity of the reclaimed oil is more preferably 45 to 60 mm²/s. The measurement method of the kinetic viscosity is as described in the Examples.

The carbon-type composition of the reclaimed oil analyzed by ring analysis is not particularly limited, but preferably, the percentage of paraffinic carbon (C_{P}%) is 55 to 80%, the percentage of naphthenic carbon (C_{N}%) is 20 to 40%, and the percentage of aromatic carbon (C_{A}%) is 0 to 15%. More preferably, the percentage of paraffinic carbon (C_{P}%) is 60 to 75%, the percentage of naphthenic carbon (C_{N}%) is 24 to 35%, and the percentage of aromatic carbon (C_{A}%) is 1 to 10%. The carbon-type by ring analysis is measured in accordance with ASTM D2140, and C_{P}% is the percentage by mass of the paraffinic carbon amount in the total carbon amount. C_{N}% is the percentage by mass of the naphthenic carbon amount in the total carbon amount, and C_{A}% is the percentage by mass of the aromatic carbon amount in the total carbon amount.

Specific examples of the reclaimed oil having the characteristics above are not particularly limited but include “NORBO52” manufactured by Northern Oil Refining pty ltd and “SORBO52” manufactured by Southern Oil Refining pty ltd. The reclaimed oils are reclaimed oils obtained by reclaiming a used engine oil from an excavator or the like.

The reclaiming method of the reclaimed oil is not particularly limited, and an example thereof is treatment of removing contaminants such as dirt, water, and fuel through filtration, desiccation, distillation, fuel removal, desalination, and/or the like. Treatment of adding an oxidation inhibitor, an anti-friction agent, and the like again may further be included.

The reclaimed oil (preferably the lubricating oil-derived reclaimed oil) content of the rubber composition is 1 to 50 parts by mass based on 100 parts by mass of the rubber component, and in the first embodiment, the content is preferably 3 to 30 parts by mass, more preferably 4 to 25 parts by mass, further preferably 5 to 20 parts by mass. In the second embodiment, the reclaimed oil content, based on 100 parts by mass of the rubber component, is preferably 3 to 40 parts by mass, more preferably 5 to 35 parts by mass, further preferably 10 to 30 parts by mass.

### [Other Components]

The rubber composition according to the embodiment may contain an additive which is generally blended in a rubber composition for a tire in addition to the rubber component, the filler, and the reclaimed oil. For example, the rubber composition may contain a silane coupling agent, zinc oxide, stearic acid, a wax, an antioxidant, a vulcanizing agent, a vulcanization accelerator, or the like as an optional component.

When silica is contained as the filler, the rubber composition preferably contains a silane coupling agent. Examples of the silane coupling agent include sulfide silane coupling agents such as bis(3-triethoxysilylpropyl)tetrasulfide, bis(3-triethoxysilylpropyl)disulfide, bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide, mercapto silane coupling agents such as 3-mercaptopropyltrimethoxysilane, 3-mercaptopropyltriethoxysilane, 3-mercaptopropylmethyldimethoxysilane, 3-mercaptopropyldimethylmethoxysilane, and mercaptoethyltriethoxysilane, and thioester group-containing silane coupling agents such as 3-octanoylthio-1-propyltriethoxysilane, 3-propionylthiopropyltrimethoxysilane, 3-hexanoylthio-1-propyltriethoxysilane, and 3-octanoylthio-1-propyltrimethoxysilane. Any one kind thereof or a combination of two or more kinds thereof can be used. The silane coupling agent content of the rubber composition is not particularly limited and may be, for example, 2 to 20 parts by mass or 5 to 15 parts by mass based on 100 parts by mass of the silica.

The zinc oxide content of the rubber composition is not particularly limited and may be, for example, 0 to 10 parts by mass, 0.5 to 5 parts by mass, or 1 to 4 parts by mass based on 100 parts by mass of the rubber component.

The stearic acid content of the rubber composition is not particularly limited and may be, for example, 0 to 10 parts by mass, 0.5 to 5 parts by mass, or 1 to 4 parts by mass based on 100 parts by mass of the rubber component.

The wax content of the rubber composition is not particularly limited and may be, for example, 0 to 5 parts by mass or 0 to 3 parts by mass based on 100 parts by mass of the rubber component in the first embodiment. In the second embodiment, the wax content may be 0 to 10 parts by mass, 0.5 to 5 parts by mass, or 1 to 4 parts by mass based on 100 parts by mass of the rubber component.

Examples of the antioxidant include various antioxidants such as amine-ketone-based, aromatic secondary amine-based, monophenol-based, bisphenol-based, and benzimidazole-based antioxidants, and any one kind thereof or a combination of two or more kinds thereof can be used. The antioxidant content of the rubber composition is not particularly limited and may be, for example, 0 to 10 parts by mass, 0.5 to 5 parts by mass, or 1 to 4 parts by mass based on 100 parts by mass of the rubber component.

As the vulcanizing agent, sulfur is preferably used, and examples thereof include powder sulfur, precipitated sulfur, insoluble sulfur, highly dispersed sulfur, and the like. The vulcanizing agent content is not particularly limited and may be, for example, 0 to 10 parts by mass, 0.5 to 5 parts by mass, or 1 to 4 parts by mass based on 100 parts by mass of the rubber component.

Examples of the vulcanization accelerator include various vulcanization accelerators such as sulfenamide-based, thiuram-based, thiazole-based, and guanidine-based vulcanization accelerators, and any one kind thereof or a combination of two or more kinds thereof can be used. The vulcanization accelerator content is not particularly limited and may be, for example, 0.1 to 10 parts by mass, 0.5 to 5 parts by mass, or 1 to 4 parts by mass based on 100 parts by mass of the rubber component.

The rubber composition for a tire according to the embodiment can be produced by kneading using a generally used mixer such as a Banbury mixer, a kneader, and a roll according to a general method. That is, for example, by adding the filler and the reclaimed oil to the rubber component and adding and mixing the additives excluding the vulcanizing agent and the vulcanization accelerator in a first mixing stage and next adding and mixing the vulcanizing agent and the vulcanization accelerator in the obtained mixture in a final mixing stage, a rubber composition for a tire can be prepared.

The rubber composition for a tire according to the embodiment can be used for tires of various sizes for various applications (preferably pneumatic tires), such as tires of passenger vehicles and large-sized tires of trucks and buses (heavy load tires), and a tire of a passenger vehicle is preferable. Examples of the applied part in a tire include various parts in a tire such as a tread, a sidewall, and a bead part. The applied part is preferably a tread rubber in the first embodiment and is a base tread in the second embodiment.

The tire according to the embodiment has a rubber member formed with the rubber composition for a tire. The tire is produced as follows. The rubber composition is formed into a predetermined form, for example, by extrusion processing according to a general method. By assembling the formed material obtained with other tire materials, a green tire is produced. The green tire is vulcanized and formed, for example, at 130 to 190° C. As a result, a tire having a vulcanized rubber obtained from the rubber composition in a rubber member can be produced.

The tire according to the first embodiment preferably has a tread rubber produced using the rubber composition according to the first embodiment. The structures of the tread rubber of a tire include a two-layer structure having a cap rubber and a base rubber and a single-layer structure in which both are combined. In the single-layer structure, the tread rubber is preferably formed with the rubber composition according to the first embodiment. In the two-layer structure, although the cap rubber on the outer side which comes into contact with the road surface is preferably formed with the rubber composition according to the first embodiment, both the cap rubber and the base rubber may be formed with the rubber composition according to the first embodiment.

The tire according to the second embodiment preferably has a base tread produced using the rubber composition according to the second embodiment. An example of the tread rubber of a tire has a two-layer structure having a cap tread on the outer side in a tire radial direction which comes into contact with the road surface and a base tread on the inner side in the tire radial direction. In a tread rubber having such a two-layer structure, the base tread is preferably formed with a vulcanized rubber obtained by vulcanizing and forming the rubber composition according to the second embodiment.

### EXAMPLES

Examples of the invention are shown below, but the invention is not limited to these Examples.

### [Oil]

### (1) Products Used

Reclaimed oil 1: “NORBO52” manufactured by Northern Oil Refining pty ltd (country of origin: Australia)
Reclaimed oil 2: “SORBO52” manufactured by Southern Oil Refining pty ltd (country of origin: Australia)
Process oil 3 (Comparative Example): “Process Oil P-200” manufactured by ENEOS Corporation

### (2) Measurement of Glass Transition Point

The glass transition point of each oil was measured using a differential scanning calorimeter (DSC) “DSC822” manufactured by METTLER TOLEDO. The sample amount of the oil was 10 to 20 mg, and the oil was homogenized by thoroughly stirring before the measurement. The measurement was started from 25° C., and the sample was cooled to −130° C. at a cooling rate of 10° C./minute, maintained at −130° C. for two minutes and then heated to 25° C. at a heating rate of 10° C./minute. The measurement was conducted in a nitrogen atmosphere, and the flow rate of the nitrogen gas was 40 mL/minute. Here, the differential scanning calorimeter was calibrated in advance using indium (In) and tin (Sn) as the calibration standard substances.

The data obtained by the measurement were analyzed using the software attached to the apparatus. Specifically, the analyzed items included Tg1: the glass transition point measured in the process from 25° C. to −130° C. and Tg2: the glass transition point measured in the process from −130° C. to 25° C. The average value of Tg1 and Tg2 was calculated as the glass transition point.

As a result, the glass transition points of the reclaimed oil 1, the reclaimed oil 2, and the process oil 3 were −82° C., −83° C., and −82° C., respectively.

### (3) Measurement of Molecular Weights

Mn, Mw, and Mw/Mn of each oil were measured using 1260 Infinity GPC manufactured by Agilent Technologies as a gel permeation chromatography (GPC) apparatus. The details are as follows.

The sample of each oil was prepared by diluting with tetrahydrofuran (THF) and filtering to remove impurities. The sample concentration was 10 mg/5 mL. For the measurement, tetrahydrofuran was used as a mobile phase, and the flow rate was 1.0 mL/minute. The injection amount was 40 μL, and the column temperature was set at 40° C. As the columns, Plgel 5μ 500 Å+100 Å+50 Å (three columns) manufactured by Agilent Technologies were used. A differential refractometer (RI) was used as the detector. Polystyrene (PS) standard substances were used for calibrating the molecular weights, and the molecular weight range of the standard substances was 580 Da to 2,000,000 Da. The chromatogram data obtained by the measurement were analyzed using the software attached to the GPC apparatus, and the number average molecular weight (Mn), the weight average molecular weight (Mw), and the molecular weight distribution (Mw/Mn) in terms of polystyrene were determined.

As a result, the reclaimed oil 1 had Mn of 600, Mw of 700, and Mw/Mn of 1.17. The reclaimed oil 2 had Mn of 630, Mw of 680, and Mw/Mn of 1.08. The process oil 3 had Mn of 490, Mw of 530, and Mw/Mn of 1.08.

### (4) Measurement of Kinetic Viscosity

As the measurement apparatus, “OmniTek U-VIsc210” manufactured by VISCOTECH CO., LTD. in accordance with ASTM D445 and ASTM D446 was used. The measurement temperature was set at 40° C., and 8 to 10 mL of the oil sample was injected into the sample injection part. The injected sample was heated to 40° C., and the kinetic viscosity was measured after observing that the temperature stabilized at 40° C.

As a result, the kinetic viscosities of the reclaimed oil 1, the reclaimed oil 2, and the process oil 3 at 40° C. were 52 mm²/s, 53 mm²/s, and 28 mm²/s, respectively.

### (5) Characteristics of Oils (Summary)

The above results of the characteristics of the reclaimed oil 1, the reclaimed oil 2, and the process oil 3 together with the carbon-type compositions by ring analysis are shown in Table 1 below.

TABLE 1

| | | Reclaimed | Reclaimed | Process |
|---|---|---|---|---|
| | | oil 1 | oil 2 | oil 3 |
| | | (NORBO52) | (SORBO52) | (P-200) |
| Glass | Tg1 (° C.) | −84 | −87 | −83 |
| transition | Tg2 (° C.) | −80 | −79 | −80 |
| point | Average value (° C.) | −82 | −83 | −82 |
| Molecular | Mn | 600 | 630 | 490 |
| weight | Mw | 700 | 680 | 530 |
| | Mw/Mn | 1.17 | 1.08 | 1.08 |
| Kinetic viscosity at 40° C. (mm²/s) | | 52 | 53 | 28 |
| Carbon- | Paraffin C_{P} % (%) | 68 | 67 | 68 |
| type | Naphthene C_{N} % (%) | 30 | 29 | 28 |
| | Aromatic C_{A} % (%) | 2 | 4 | 4 |

### Blended Components of Rubber Composition

As the components blended in the rubber compositions, the components below were used in addition to the reclaimed oils 1 and 2 and the process oil 3.
SBR: “ESBR1502” manufactured by ENEOS Materials Corporation
BR: “UBEPOL BR150B” manufactured by UBE Elastomer Co. Ltd.
NR: “RS S#3” manufactured by Southland Rubber
Silica: “TOKUSIL USG-A” manufactured by OSC SIAM SILICA
Silane: sulfide silane coupling agent,“Si75” manufactured by Eyonik Japan Co., Ltd.
Carbon black A: “Diablack N339” manufactured by Mitsubishi Chemical Corporation
Carbon black B: T-NS, N₂SA=74 m²/g,“Seast N” manufactured by TOKAI CARBON CO., LTD.
Zinc oxide: “Zinc Oxide, Type 2” manufactured by MITSUI MINING & SMELTING CO., LTD.
Wax: paraffin wax, “OZOACE-27011” manufactured by NIPPON SEIRO CO., LTD.
Stearic acid: “Stearic Acid N-50” manufactured by NOF CORPORATION
Antioxidant A: 6PPD,“Nocrac 6C” manufactured by OUCHI SHINKO CHEMICAL INDUSTRIAL CO., LTD.
Antioxidant B: TMQ,“Vulkanox HS/LG” manufactured by Lanxess AG
Sulfur: “Oil-Treated l50 Mesh Powder Sulfur” manufactured by Tsurumi Chemical Industry Co., ltd.
Vulcanization accelerator A:“Nocceler CZ-G” manufactured by OUCHI SHINKO CHEMICAL INDUSTRIAL CO., LTD.
Vulcanization accelerator B:“Soxinol D-G” manufactured by Sumitomo Chemical Co., Ltd.

### [Evaluation Methods of Rubber Composition]

### (1) Abrasion Resistance

The abrasion resistance was evaluated using the modified Lambourn abrasion test of JIS K6264-2:2005 as a reference standard. Specifically, a fully automated Lambourn abrasion tester manufactured by Ryuuss Co., Ltd was used, and black silicon carbide C-80 (particle size F80) manufactured by ATSUCHI TEKKO CO., LTD. was used as a buffing wheel. The sample shape was a disk shape having an outer diameter of 45 mm and a thickness of 10 mm, and the center part had a shape suitable for attachment to a specialized jig. Samples were produced by vulcanizing at 160° C. for 20 minutes using a specialized mold. The number of the samples was n=2 for each type of the samples. The measurement conditions were a slip rate of 50%, a load of 3.0 kg, a falling sand rate of 15 g/minute, a grindstone particle diameter of 80 mesh, a sample rotation rate of 480 rpm, and a test temperature of 23° C. First, preliminary abrasion was conducted for 1.0 minute under the measurement conditions, and the mass of the sample after the preliminary abrasion was measured. Next, main abrasion was conducted for 2.5 minutes under the measurement conditions, and the mass of the sample after the main abrasion was measured. The specific gravities of the control rubber and the sample were measured with a densimeter. The abrasion resistance index was calculated by the following equation from the masses of the sample before and after the main abrasion and the specific gravities.

$$Abrasion resistance index = \{ ( {W}_{0 C} - {W}_{C} ) \times S {G}_{C} / ( {W}_{0 S} - {W}_{S} ) \times S {G}_{S} \} \times 100$$

(W_{0C}: the mass of the control rubber before the main abrasion
W_{C}: the mass of the control rubber after the main abrasion
W_{0S}: the mass of the sample before the main abrasion
W_{S}: the mass of the sample after the main abrasion
SG_{C}: the specific gravity of the control rubber
SG_{S}: the specific gravity of the sample)

Using the Comparative Examples in Tables 2 to 8 below as control rubbers, the abrasion resistances of the Examples were evaluated. The larger index means the more excellent abrasion resistance.

### (2) Fatigue Resistance

The fatigue resistance was evaluated using JIS K6260:2017 as a reference standard. Specifically, an L-iR-20 De Mattia flexing tester manufactured by YASUDA SEIKI SEISAKUSHO, LTD. was used as a tester. A piece of about 30 g with about 150 mm (non-grain direction)×55 mm (grain direction) was cut out of a rubber composition formed into a sheet of about 2 mm and vulcanized at 160° C. for 20 minutes, and a vulcanized sample in which the thickness of the center in the elongated part of the sample (the minimum thickness of the groove formed in the center) was 0.55 mm was produced. The vulcanized sample was deteriorated at 90° C. for two days, and a test piece was produced by punching with a specialized jig. The number of the test pieces was 12 in each of the Examples and the Comparative Examples. The inside of the test tank was set at 40° C., and the stroke was adjusted to achieve a certain elongation rate. The initial length was 30 mm, and the maximum chuck distance was set at 60 mm (100% elongation). A flexing test was conducted, and the number of flexing tests performed until the test piece was cut was counted. The average value of the numbers of flexing tests at a point in time when the middle six pieces of the 12 pieces were cut was determined and expressed with an index, where the value of each of the Comparative Examples in Tables 2 to 8 below was regarded as 100. The larger index means the more excellent fatigue resistance.

### (3) Breaking Property

The tensile strength of a vulcanized rubber was measured in accordance with JIS K6251:2017. Specifically, the rubber composition was vulcanized at 160° C. for 20 minutes, and a test piece having a thickness of 2 mm was produced using a punching blade of type 3 dumbbell shape. The measurement was conducted under the conditions of a test temperature of 23±2° C. and a relative humidity of 50±5%. The test piece was set in a tensile tester, and a tensile test was conducted at a rate of 500 mm/minute. A tensile force was applied until the test piece broke to determine the maximum load (N) at break, and the tensile strength (MPa) was determined by dividing the maximum load by the sectional area (mm²) of the test piece before the test. The result was expressed with an index, where the tensile strength value of each of the Comparative Examples in Tables 9 to 18 below was regarded as 100. The larger index means the larger tensile strength and the more excellent breaking property.

### (4) Low Heat Generation Property

The low heat generation property was evaluated using a viscoelasticity analyzer “VR-7110” manufactured by Ueshima Seisakusho Co., Ltd. Specifically, the rubber composition was pressed and vulcanized into a plate having a thickness of 2.0 mm using a sample mold of 25 mm×130 mm in such a manner that the vibration direction during the tensile test would be the same as the grain direction. A test piece having a thickness of 2.0 mm, a width of 4.0 mm, and a chuck distance of 10 mm was produced from the obtained vulcanized rubber. For the test conditions, the measurement apparatus was set to the strain-temperature sweep measurement mode, and tensile deformation of static strain of 10%, dynamic strain of 5.0%, and frequency of 10 Hz was applied to measure the tan δ at a temperature of 35° C. The reciprocal of the tan δ was expressed with an index, where the value of each of the Comparative Examples in Tables 9 to 18 below was regarded as 100. The larger index means the smaller tan δ, meaning that the sample is less likely to generate heat, in other words, the low heat generation property is more excellent. The more excellent the low heat generation property, the more excellent the low fuel consumption as a tire.

### First Experimental Example

Rubber compositions were prepared according to the formulations (parts by mass) shown in Table 2 below using a Banbury mixer. Specifically, first, the agents to be blended excluding sulfur and the vulcanization accelerators were added to and kneaded in the rubber component, and next, sulfur and the vulcanization accelerators were added to and kneaded in the obtained kneaded material. Thus, the rubber compositions of Examples 1 and 2 and Comparative Example 1 were prepared.

The abrasion resistance and the fatigue resistance of the obtained rubber compositions were evaluated. The results are as shown in Table 2 below. Compared to Comparative Example 1 as a control, in which the process oil 3 was used, the abrasion resistance and the fatigue resistance improved in Examples 1 and 2, in which the reclaimed oil 1 and 2 were respectively used.

TABLE 2

| | Comp. Ex. 1 | Ex. 1 | Ex. 2 |
|---|---|---|---|
| Formulation | | | |
| (parts by mass) | | | |
| SBR | 100 | 100 | 100 |
| Silica | 50 | 50 | 50 |
| Silane | 4 | 4 | 4 |
| Carbon black A | 15 | 15 | 15 |
| Process oil 3 | 10 | | |
| Reclaimed oil 1 | | 10 | |
| Reclaimed oil 2 | | | 10 |
| Zinc oxide | 2 | 2 | 2 |
| Stearic acid | 2 | 2 | 2 |
| Antioxidant A | 2 | 2 | 2 |
| Sulfur | 1.8 | 1.8 | 1.8 |
| Vulcanization accelerator A | 1.8 | 1.8 | 1.8 |
| Vulcanization accelerator B | 1.3 | 1.3 | 1.3 |
| Evaluation (index) | | | |
| Abrasion resistance | 100 | 106 | 104 |
| Fatigue resistance | 100 | 108 | 104 |

### Second Experimental Example

The rubber compositions of Examples 3 and 4 and the rubber composition of Comparative Example 2 as a control were prepared in the same manner as in the first experimental example but according to the formulations (parts by mass) shown in Table 3 below. The second experimental example is an example in which the silica amount was increased to 100 parts by mass. The abrasion resistance and the fatigue resistance were evaluated using the obtained rubber compositions.

TABLE 3

| | Comp. Ex. 2 | Ex. 3 | Ex. 4 |
|---|---|---|---|
| Formulation | | | |
| (parts by mass) | | | |
| SBR | 100 | 100 | 100 |
| Silica | 100 | 100 | 100 |
| Silane | 8 | 8 | 8 |
| Carbon black A | 15 | 15 | 15 |
| Process oil 3 | 10 | | |
| Reclaimed oil 1 | | 10 | |
| Reclaimed oil 2 | | | 10 |
| Zinc oxide | 2 | 2 | 2 |
| Stearic acid | 2 | 2 | 2 |
| Antioxidant A | 2 | 2 | 2 |
| Sulfur | 1.8 | 1.8 | 1.8 |
| Vulcanization accelerator A | 1.8 | 1.8 | 1.8 |
| Vulcanization accelerator B | 1.3 | 1.3 | 1.3 |
| Evaluation (index) | | | |
| Abrasion resistance | 100 | 104 | 104 |
| Fatigue resistance | 100 | 108 | 106 |

### Third Experimental Example

The rubber compositions of Examples 5 and 6 and the rubber composition of Comparative Example 3 as a control were prepared in the same manner as in the first experimental example but according to the formulations (parts by mass) shown in Table 4 below. The third experimental example is an example in which the silica amount was increased to 150 parts by mass. The abrasion resistance and the fatigue resistance were evaluated using the obtained rubber compositions.

TABLE 4

| | Comp. Ex. 3 | Ex. 5 | Ex. 6 |
|---|---|---|---|
| Formulation | | | |
| (parts by mass) | | | |
| SBR | 100 | 100 | 100 |
| Silica | 150 | 150 | 150 |
| Silane | 12 | 12 | 12 |
| Carbon black A | 15 | 15 | 15 |
| Process oil 3 | 10 | | |
| Reclaimed oil 1 | | 10 | |
| Reclaimed oil 2 | | | 10 |
| Zinc oxide | 2 | 2 | 2 |
| Stearic acid | 2 | 2 | 2 |
| Antioxidant A | 2 | 2 | 2 |
| Sulfur | 1.8 | 1.8 | 1.8 |
| Vulcanization accelerator A | 1.8 | 1.8 | 1.8 |
| Vulcanization accelerator B | 1.3 | 1.3 | 1.3 |
| Evaluation (index) | | | |
| Abrasion resistance | 100 | 102 | 103 |
| Fatigue resistance | 100 | 103 | 106 |

### Fourth Experimental Example

The rubber compositions of Examples 7 and 8 and the rubber composition of Comparative Example 4 as a control were prepared in the same manner as in the first experimental example but according to the formulations (parts by mass) shown in Table 5 below. The fourth experimental example is an example in which the rubber component was SBR/BR/NR. The abrasion resistance and the fatigue resistance were evaluated using the obtained rubber compositions.

TABLE 5

| | Comp. Ex. 4 | Ex. 7 | Ex. 8 |
|---|---|---|---|
| Formulation | | | |
| (parts by mass) | | | |
| SBR | 20 | 20 | 20 |
| BR | 40 | 40 | 40 |
| NR | 40 | 40 | 40 |
| Silica | 50 | 50 | 50 |
| Silane | 4 | 4 | 4 |
| Carbon black A | 15 | 15 | 15 |
| Process oil 3 | 10 | | |
| Reclaimed oil 1 | | 10 | |
| Reclaimed oil 2 | | | 10 |
| Zinc oxide | 2 | 2 | 2 |
| Stearic acid | 2 | 2 | 2 |
| Antioxidant A | 2 | 2 | 2 |
| Sulfur | 1.8 | 1.8 | 1.8 |
| Vulcanization accelerator A | 1.8 | 1.8 | 1.8 |
| Vulcanization accelerator B | 1.3 | 1.3 | 1.3 |
| Evaluation (index) | | | |
| Abrasion resistance | 100 | 106 | 103 |
| Fatigue resistance | 100 | 110 | 111 |

### Fifth Experimental Example

The rubber compositions of Examples 9 and 10 and the rubber composition of Comparative Example 5 as a control were prepared in the same manner as in the first experimental example but according to the formulations (parts by mass) shown in Table 6 below. The fifth experimental example is an example in which the rubber component was SBR/NR. The abrasion resistance and the fatigue resistance were evaluated using the obtained rubber compositions.

TABLE 6

| | Comp. Ex. 5 | Ex. 9 | Ex. 10 |
|---|---|---|---|
| Formulation | | | |
| (parts by mass) | | | |
| SBR | 80 | 80 | 80 |
| NR | 20 | 20 | 20 |
| Silica | 50 | 50 | 50 |
| Silane | 5 | 5 | 5 |
| Carbon black A | 15 | 15 | 15 |
| Process oil 3 | 10 | | |
| Reclaimed oil 1 | | 10 | |
| Reclaimed oil 2 | | | 10 |
| Zinc oxide | 2 | 2 | 2 |
| Stearic acid | 2 | 2 | 2 |
| Antioxidant A | 2 | 2 | 2 |
| Sulfur | 1.8 | 1.8 | 1.8 |
| Vulcanization accelerator A | 1.8 | 1.8 | 1.8 |
| Vulcanization accelerator B | 1.3 | 1.3 | 1.3 |
| Evaluation (index) | | | |
| Abrasion resistance | 100 | 102 | 103 |
| Fatigue resistance | 100 | 103 | 102 |

### Sixth Experimental Example

The rubber compositions of Examples 11 and 12 and the rubber composition of Comparative Example 6 as a control were prepared in the same manner as in the first experimental example but according to the formulations (parts by mass) shown in Table 7 below. The sixth experimental example is an example in which the oil amount was increased. The abrasion resistance and the fatigue resistance were evaluated using the obtained rubber compositions.

TABLE 7

| | Comp. Ex. 6 | Ex. 11 | Ex. 12 |
|---|---|---|---|
| Formulation | | | |
| (parts by mass) | | | |
| SBR | 100 | 100 | 100 |
| Silica | 50 | 50 | 50 |
| Silane | 4 | 4 | 4 |
| Carbon black A | 15 | 15 | 15 |
| Process oil 3 | 20 | | |
| Reclaimed oil 1 | | 20 | |
| Reclaimed oil 2 | | | 20 |
| Zinc oxide | 2 | 2 | 2 |
| Stearic acid | 2 | 2 | 2 |
| Antioxidant A | 2 | 2 | 2 |
| Sulfur | 1.8 | 1.8 | 1.8 |
| Vulcanization accelerator A | 1.8 | 1.8 | 1.8 |
| Vulcanization accelerator B | 1.3 | 1.3 | 1.3 |
| Evaluation (index) | | | |
| Abrasion resistance | 100 | 103 | 102 |
| Fatigue resistance | 100 | 102 | 103 |

### Seventh Experimental Example

The rubber compositions of Examples 13 and 14 and the rubber composition of Comparative Example 7 as a control were prepared in the same manner as in the first experimental example but according to the formulations (parts by mass) shown in Table 8 below. The seventh experimental example is an example in which the oil amount was further increased. The abrasion resistance and the fatigue resistance were evaluated using the obtained rubber compositions.

TABLE 8

| | Comp. Ex. 7 | Ex. 13 | Ex. 14 |
|---|---|---|---|
| Formulation | | | |
| (parts by mass) | | | |
| SBR | 100 | 100 | 100 |
| Silica | 50 | 50 | 50 |
| Silane | 4 | 4 | 4 |
| Carbon black A | 15 | 15 | 15 |
| Process oil 3 | 30 | | |
| Reclaimed oil 1 | | 30 | |
| Reclaimed oil 2 | | | 30 |
| Zinc oxide | 2 | 2 | 2 |
| Stearic acid | 2 | 2 | 2 |
| Antioxidant A | 2 | 2 | 2 |
| Sulfur | 1.8 | 1.8 | 1.8 |
| Vulcanization accelerator A | 1.8 | 1.8 | 1.8 |
| Vulcanization accelerator B | 1.3 | 1.3 | 1.3 |
| Evaluation (index) | | | |
| Abrasion resistance | 100 | 104 | 102 |
| Fatigue resistance | 100 | 102 | 104 |

As shown in Tables 2 to 8, the abrasion resistance and the fatigue resistance improved in Examples 1 to 14, in which the reclaimed oil 1 or 2 was blended instead of the existing process oil, compared to the respective values of Comparative Examples 1 to 7 as a control, in which the process oil 3 was blended. Accordingly, it can be seen that the sustainability, the abrasion resistance, and the fatigue resistance are excellent when the reclaimed oil 1 or 2 is blended.

### Eighth Experimental Example

Rubber compositions were prepared according to the formulations (parts by mass) shown in Table 9 below using a Banbury mixer. Specifically, first, the agents to be blended excluding sulfur and the vulcanization accelerators were added to and kneaded in the rubber component, and next, sulfur and the vulcanization accelerators were added to and kneaded in the obtained kneaded material. Thus, the rubber compositions of Examples 15 and 16 and Comparative Example 8 were prepared.

The breaking property and the low heat generation property of the obtained rubber compositions were evaluated. The results are as shown in Table 9 below. Compared to Comparative Example 8 as a control, in which the process oil 3 was used, the breaking property and the low heat generation property improved in Examples 15 and 16, in which the reclaimed oil 1 and 2 were respectively used.

TABLE 9

| | Comp. Ex. 8 | Ex. 15 | Ex. 16 |
|---|---|---|---|
| Formulation | | | |
| (parts by mass) | | | |
| BR | 30 | 30 | 30 |
| NR | 50 | 50 | 50 |
| SBR | 20 | 20 | 20 |
| Stearic acid | 2 | 2 | 2 |
| Zinc oxide | 2 | 2 | 2 |
| Wax | 2 | 2 | 2 |
| Antioxidant A | 1 | 1 | 1 |
| Antioxidant B | 0.5 | 0.5 | 0.5 |
| Carbon black B | 70 | 70 | 70 |
| Process oil 3 | 25 | | |
| Reclaimed oil 1 | | 25 | |
| Reclaimed oil 2 | | | 25 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 101 | 101 |
| Low heat generation property | 100 | 101 | 101 |

### Ninth Experimental Example

The rubber compositions of Examples 17 and 18 and the rubber composition of Comparative Example 9 as a control were prepared in the same manner as in the eighth experimental example but according to the formulations (parts by mass) shown in Table 10 below. The ninth experimental example is an example in which the carbon black amount was decreased to 20 parts by mass. The breaking property and the low heat generation property were evaluated using the obtained rubber compositions.

TABLE 10

| | Comp. Ex. 9 | Ex. 17 | Ex. 18 |
|---|---|---|---|
| Formulation | | | |
| (parts by mass) | | | |
| BR | 30 | 30 | 30 |
| NR | 50 | 50 | 50 |
| SBR | 20 | 20 | 20 |
| Stearic acid | 2 | 2 | 2 |
| Zinc oxide | 2 | 2 | 2 |
| Wax | 2 | 2 | 2 |
| Antioxidant A | 1 | 1 | 1 |
| Antioxidant B | 0.5 | 0.5 | 0.5 |
| Carbon black B | 20 | 20 | 20 |
| Process oil 3 | 25 | | |
| Reclaimed oil 1 | | 25 | |
| Reclaimed oil 2 | | | 25 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 104 | 103 |
| Low heat generation property | 100 | 101 | 101 |

### Tenth Experimental Example

The rubber compositions of Examples 19 and 20 and the rubber composition of Comparative Example 10 as a control were prepared in the same manner as in the eighth experimental example but according to the formulations (parts by mass) shown in Table 11 below. The tenth experimental example is an example in which the carbon black amount was increased to 100 parts by mass. The breaking property and the low heat generation property were evaluated using the obtained rubber compositions.

TABLE 11

| | Comp. Ex. 10 | Ex. 19 | Ex. 20 |
|---|---|---|---|
| Formulation | | | |
| (parts by mass) | | | |
| BR | 30 | 30 | 30 |
| NR | 50 | 50 | 50 |
| SBR | 20 | 20 | 20 |
| Stearic acid | 2 | 2 | 2 |
| Zinc oxide | 2 | 2 | 2 |
| Wax | 2 | 2 | 2 |
| Antioxidant A | 1 | 1 | 1 |
| Antioxidant B | 0.5 | 0.5 | 0.5 |
| Carbon black B | 100 | 100 | 100 |
| Process oil 3 | 25 | | |
| Reclaimed oil 1 | | 25 | |
| Reclaimed oil 2 | | | 25 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 103 | 104 |
| Low heat generation property | 100 | 102 | 101 |

### Eleventh Experimental Example

The rubber compositions of Examples 21 and 22 and the rubber composition of Comparative Example 11 as a control were prepared in the same manner as in the eighth experimental example but according to the formulations (parts by mass) shown in Table 12 below. The eleventh experimental example is an example in which the rubber component was NR alone. The breaking property and the low heat generation property were evaluated using the obtained rubber compositions.

TABLE 12

| | Comp. Ex. 11 | Ex. 21 | Ex. 22 |
|---|---|---|---|
| Formulation | | | |
| (parts by mass) | | | |
| NR | 100 | 100 | 100 |
| Stearic acid | 2 | 2 | 2 |
| Zinc oxide | 2 | 2 | 2 |
| Wax | 2 | 2 | 2 |
| Antioxidant A | 1 | 1 | 1 |
| Antioxidant B | 0.5 | 0.5 | 0.5 |
| Carbon black B | 70 | 70 | 70 |
| Process oil 3 | 25 | | |
| Reclaimed oil 1 | | 25 | |
| Reclaimed oil 2 | | | 25 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 102 | 101 |
| Low heat generation property | 100 | 102 | 102 |

### Twelfth Experimental Example

The rubber compositions of Examples 23 and 24 and the rubber composition of Comparative Example 12 as a control were prepared in the same manner as in the eighth experimental example but according to the formulations (parts by mass) shown in Table 13 below. The twelfth experimental example is an example in which the rubber component was NR alone and in which the carbon black amount was 20 parts by mass. The breaking property and the low heat generation property were evaluated using the obtained rubber compositions.

TABLE 13

| | Comp. Ex. 12 | Ex. 23 | Ex. 24 |
|---|---|---|---|
| Formulation | | | |
| (parts by mass) | | | |
| NR | 100 | 100 | 100 |
| Stearic acid | 2 | 2 | 2 |
| Zinc oxide | 2 | 2 | 2 |
| Wax | 2 | 2 | 2 |
| Antioxidant A | 1 | 1 | 1 |
| Antioxidant B | 0.5 | 0.5 | 0.5 |
| Carbon black B | 20 | 20 | 20 |
| Process oil 3 | 25 | | |
| Reclaimed oil 1 | | 25 | |
| Reclaimed oil 2 | | | 25 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 104 | 103 |
| Low heat generation property | 100 | 102 | 101 |

### Thirteenth Experimental Example

The rubber compositions of Examples 25 and 26 and the rubber composition of Comparative Example 13 as a control were prepared in the same manner as in the eighth experimental example but according to the formulations (parts by mass) shown in Table 14 below. The thirteenth experimental example is an example in which the rubber component was NR alone and in which the carbon black amount was 100 parts by mass. The breaking property and the low heat generation property were evaluated using the obtained rubber compositions.

TABLE 14

| | Comp. Ex. 13 | Ex. 25 | Ex. 26 |
|---|---|---|---|
| Formulation | | | |
| (parts by mass) | | | |
| NR | 100 | 100 | 100 |
| Stearic acid | 2 | 2 | 2 |
| Zinc oxide | 2 | 2 | 2 |
| Wax | 2 | 2 | 2 |
| Antioxidant A | 1 | 1 | 3 |
| Antioxidant B | 0.5 | 0.5 | 0.5 |
| Carbon black B | 100 | 100 | 100 |
| Process oil 3 | 25 | | |
| Reclaimed oil 1 | | 25 | |
| Reclaimed oil 2 | | | 25 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 103 | 103 |
| Low heat generation property | 100 | 102 | 102 |

### Fourteenth Experimental Example

The rubber compositions of Examples 27 and 28 and the rubber composition of Comparative Example 14 as a control were prepared in the same manner as in the eighth experimental example but according to the formulations (parts by mass) shown in Table 15 below. The fourteenth experimental example is an example in which the oil amount was decreased compared to that of the eighth experimental example. The breaking property and the low heat generation property were evaluated using the obtained rubber compositions.

TABLE 15

| | Comp. Ex. 14 | Ex. 27 | Ex. 28 |
|---|---|---|---|
| Formulation | | | |
| (parts by mass) | | | |
| BR | 30 | 30 | 30 |
| NR | 50 | 50 | 50 |
| SBR | 20 | 20 | 20 |
| Stearic acid | 2 | 2 | 2 |
| Zinc oxide | 2 | 2 | 2 |
| Wax | 2 | 2 | 2 |
| Antioxidant A | 1 | 1 | 1 |
| Antioxidant B | 0.5 | 0.5 | 0.5 |
| Carbon black B | 70 | 70 | 70 |
| Process oil 3 | 10 | | |
| Reclaimed oil 1 | | 10 | |
| Reclaimed oil 2 | | | 10 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 102 | 103 |
| Low heat generation property | 100 | 102 | 102 |

### Fifteenth Experimental Example

The rubber compositions of Examples 29 and 30 and the rubber composition of Comparative Example 15 as a control were prepared in the same manner as in the eighth experimental example but according to the formulations (parts by mass) shown in Table 16 below. The fifteenth experimental example is an example in which the oil amount was increased compared to that of the eighth experimental example. The breaking property and the low heat generation property were evaluated using the obtained rubber compositions.

TABLE 16

| | Comp. Ex. 15 | Ex. 29 | Ex. 30 |
|---|---|---|---|
| Formulation | | | |
| (parts by mass) | | | |
| BR | 30 | 30 | 30 |
| NR | 50 | 50 | 50 |
| SBR | 20 | 20 | 20 |
| Stearic acid | 2 | 2 | 2 |
| Zinc oxide | 2 | 2 | 2 |
| Wax | 2 | 2 | 2 |
| Antioxidant A | 1 | 1 | 1 |
| Antioxidant B | 0.5 | 0.5 | 0.5 |
| Carbon black B | 70 | 70 | 70 |
| Process oil 3 | 40 | | |
| Reclaimed oil 1 | | 40 | |
| Reclaimed oil 2 | | | 40 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 102 | 102 |
| Low heat generation property | 100 | 102 | 101 |

### Sixteenth Experimental Example

The rubber compositions of Examples 31 and 32 and the rubber composition of Comparative Example 16 as a control were prepared in the same manner as in the eighth experimental example but according to the formulations (parts by mass) shown in Table 17 below. The sixteenth experimental example is an example in which the oil amount was decreased compared to that of the eleventh experimental example. The breaking property and the low heat generation property were evaluated using the obtained rubber compositions.

TABLE 17

| | Comp. Ex. 16 | Ex. 31 | Ex. 32 |
|---|---|---|---|
| Formulation | | | |
| (parts by mass) | | | |
| NR | 100 | 100 | 100 |
| Stearic acid | 2 | 2 | 2 |
| Zinc oxide | 2 | 2 | 2 |
| Wax | 2 | 2 | 2 |
| Antioxidant A | 1 | 1 | 1 |
| Antioxidant B | 0.5 | 0.5 | 0.5 |
| Carbon black B | 70 | 70 | 70 |
| Process oil 3 | 10 | | |
| Reclaimed oil 1 | | 10 | |
| Reclaimed oil 2 | | | 10 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 102 | 101 |
| Low heat generation property | 100 | 102 | 102 |

### Seventeenth Experimental Example

The rubber compositions of Examples 33 and 34 and the rubber composition of Comparative Example 17 as a control were prepared in the same manner as in the eighth experimental example but according to the formulations (parts by mass) shown in Table 18 below. The seventeenth experimental example is an example in which the oil amount was increased compared to that of the eleventh experimental example. The breaking property and the low heat generation property were evaluated using the obtained rubber compositions.

TABLE 18

| | Comp. Ex. 17 | Ex. 33 | Ex. 34 |
|---|---|---|---|
| Formulation | | | |
| (parts by mass) | | | |
| NR | 100 | 100 | 100 |
| Stearic acid | 2 | 2 | 2 |
| Zinc oxide | 2 | 2 | 2 |
| Wax | 2 | 2 | 2 |
| Antioxidant A | 1 | 1 | 1 |
| Antioxidant B | 0.5 | 0.5 | 0.5 |
| Carbon black B | 70 | 70 | 70 |
| Process oil 3 | 40 | | |
| Reclaimed oil 1 | | 40 | |
| Reclaimed oil 2 | | | 40 |
| Vulcanization accelerator A | 0.5 | 0.5 | 0.5 |
| Vulcanization accelerator B | 1.5 | 1.5 | 1.5 |
| Sulfur | 2 | 2 | 2 |
| Evaluation (index) | | | |
| Breaking property | 100 | 102 | 102 |
| Low heat generation property | 100 | 102 | 101 |

As shown in Tables 9 to 18, the breaking property and the low heat generation property improved in Examples 15 to 34, in which the reclaimed oil 1 or 2 was blended instead of the existing process oil, compared to the respective values of Comparative Examples 8 to 17 as controls, in which the process oil 3 was blended. Accordingly, it can be seen that the sustainability, the breaking property, and the low fuel consumption are excellent when the reclaimed oil 1 or 2 is blended.

In this regard, the upper limits and the lower limits of the various numerical ranges described in the specification can be combined freely, and all the combinations should be regarded as being described as preferable numerical ranges in the present specification. Moreover, a numerical range “X to Y” means X or more and Y or less.

What is claimed is:

1. A rubber composition for a tire, comprising:
100 parts by mass of a rubber component containing a diene rubber; and
1 to 50 parts by mass of a mineral oil-derived reclaimed oil.

2. The rubber composition for a tire according to claim 1, further comprising 30 to 200 parts by mass of silica,
wherein 100 parts by mass of the rubber component contain 20 to 100 parts by mass of a styrene butadiene rubber.

3. The rubber composition for a tire according to claim 1, further comprising 15 to 200 parts by mass of carbon black,
wherein 100 parts by mass of the rubber component contain 20 to 100 parts by mass of a natural rubber.

4. The rubber composition for a tire according to claim 2, wherein the mineral oil-derived reclaimed oil is a lubricating oil-derived reclaimed oil.

5. The rubber composition for a tire according to claim 3, wherein the mineral oil-derived reclaimed oil is a lubricating oil-derived reclaimed oil.

6. The rubber composition for a tire according to claim 2, wherein the mineral oil-derived reclaimed oil has a glass transition point of −90° C. to −75° C., a number average molecular weight of 550 to 650, and a weight average molecular weight of 600 to 750.

7. The rubber composition for a tire according to claim 3, wherein the mineral oil-derived reclaimed oil has a glass transition point of −90° C. to −75° C., a number average molecular weight of 550 to 650, and a weight average molecular weight of 600 to 750.

8. The rubber composition for a tire according to claim 2, wherein 100 parts by mass of the rubber component contain 70 to 100 parts by mass of the styrene butadiene rubber.

9. The rubber composition for a tire according to claim 2, wherein 100 parts by mass of the rubber component contain 20 to 40 parts by mass of the styrene butadiene rubber, 30 to 50 parts by mass of a butadiene rubber, and 30 to 50 parts by mass of a natural rubber.

10. The rubber composition for a tire according to claim 3, wherein 100 parts by mass of the rubber component contain 70 to 100 parts by mass of the natural rubber and 0 to 30 parts by mass of a butadiene rubber and/or a styrene butadiene rubber.

11. The rubber composition for a tire according to claim 3, wherein 100 parts by mass of the rubber component contain 30 to 70 parts by mass of the natural rubber, 10 to 50 parts by mass of a butadiene rubber, and 0 to 40 parts by mass of a styrene butadiene rubber.

12. The rubber composition for a tire according to claim 2, wherein the kinetic viscosity of the mineral oil-derived reclaimed oil at 40° C. is 40 to 70 mm²/s.

13. The rubber composition for a tire according to claim 3, wherein the kinetic viscosity of the mineral oil-derived reclaimed oil at 40° C. is 40 to 70 mm²/s.

14. The rubber composition for a tire according to claim 2, wherein in the carbon-type composition of the mineral oil-derived reclaimed oil analyzed by ring analysis, the percentage of paraffinic carbon (C_{P}%) is 55 to 80%, the percentage of naphthenic carbon (C_{N}%) is 20 to 40%, and the percentage of aromatic carbon (C_{A}%) is 0 to 15%.

15. The rubber composition for a tire according to claim 3, wherein in the carbon-type composition of the mineral oil-derived reclaimed oil analyzed by ring analysis, the percentage of paraffinic carbon (C_{P}%) is 55 to 80%, the percentage of naphthenic carbon (C_{N}%) is 20 to 40%, and the percentage of aromatic carbon (C_{A}%) is 0 to 15%.

16. A tire comprising a rubber member formed with the rubber composition for a tire according to claim 1.

17. A tire comprising a rubber member formed with the rubber composition for a tire according to claim 2.

18. The tire according to claim 17, wherein the rubber member is a tread rubber.

19. A tire comprising a rubber member formed with the rubber composition for a tire according to claim 3.

20. The tire according to claim 19, wherein the rubber member is a base tread.
